(19) United States
(12) Patent Application Publication
(10) Pub. No.: US 2006/0266804 A1
(43) Pub. Date: Nov. 30, 2006

(54) Chip package and wire bonding process thereof

(76) Inventors: Chin Shih Wang, Kaohsiung City (TW); Shu Huei Huang, Kaohsiung City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/435,136

(22) Filed: May 17, 2006

(30) Foreign Application Priority Data
May 17, 2005 (TW) 094115863

(51) Int. Cl. A47J 36/02

(52) U.S. Cl. 228/101

(57) ABSTRACT

A chip package and the wire bonding process thereof are provided. The chip package includes a circuit substrate, a chip, a bonding wire, and a leaning block, wherein the circuit substrate has a bonding surface and at least one contact disposed on the bonding surface. In addition, the chip is disposed on the bonding surface of the circuit substrate, wherein the chip has an active surface facing opposite to the circuit substrate and at least one bonding pad disposed on the active surface. Furthermore, the leaning block is disposed on the contact. The bonding wire connects the bonding pad and contact and passes over the leaning block. The chip package and the wire bonding process thereof can prevent the bonding wire from drooping and thus avoid bridging to other lines on the circuit substrate. The processing yields can be improved accordingly.

### CROSS REFERENCE TO RELATED APPLICATION

This application claims the priority benefit of Taiwan Patent Application Serial Number 094115863 filed May 17, 2005, the full disclosure of which is incorporated herein by reference.

### BACKGROUND OF THE INVENTION

1. Field of the Invention

The invention relates to a semiconductor device and the process for manufacturing the same, and more particularly, to a chip package and the wire bonding process thereof.

2. Description of the Related Art

In the information society of nowadays, the demands for a variety of electronics devices have arisen. The evolution of technique of chip package is also following the advances of the electronics devices in digitization, networked connection, localization and user-friendly systems. The wire bonding process and flip-chip bonding process are two most common processes for packaging chips, wherein the flip-chip bonding process is to bond a chip to a carrier via bumps and the wiring length for connecting the chip to the carrier is shortened substantially. This is helpful to speed up the signal transmission between the chip and the carrier. However, the flip-chip bonding process is much more time-consuming and costly than the wire bonding process. Accordingly, the wire bonding process is still the one commonly used by manufactures to produce the electronics devices that have low count pins or are low cost.

Referring to FIG. 1, which is a schematic diagram showing that a chip is bonded to a circuit substrate by a conventional wire bonding process. As shown in FIG. 1, firstly, one end of a bonding wire 130 is bonded to the bonding pad 112 of a chip 110 by the conventional wire bonding process. Secondly, the bonding wire 130 is pulled up and aside a distance from the bonding pad 112 and then is pulled down to be bonded to the contact 122 of a circuit substrate 120. Lastly, the bonding wire 130 is stitched on the contact 122 and drawn out.

With the advance in semiconductor technology, the semiconductor devices continue being designed toward higher integration and lower profile. The line pitch on the circuit substrate 120 is getting narrower accordingly. However, the resulting wire 130 usually has a slightly drooping profile after bonding, the part of the wire 130 near the contact 122 is likely to droop and contact the ground loop 124, power loop 126 or other lines on the circuit substrate 120 (as shown on the area encircled by dashed line in FIG. 1). This will cause the occurrence of short circuit and lower the processing yield. The production cost is increased accordingly.

Referring to FIG. 2, which is a schematic diagram showing that a chip is bonded to a circuit substrate by another conventional wire bonding process. As shown in FIG. 2, the wire bonding process is to form insulation films 140 on a ground ring 124 and a power ring 126 whereby the insulation films 140 can prevent the bonding wire 130 from electrically contacting the ground ring 124 and power ring 126. This can avoid the occurrence of short circuit. However, because the gaps of the elements on the circuit substrate are getting close, this conventional process, as a result of process limitation and inaccurate processing, is unable to form the insulation films 140 right on the ground ring 125 and the power ring 126. This will limit the application of the conventional process and reduce the effect on prevention of short circuit.

Accordingly, there exists a need to provide a solution to the aforesaid problems to increase the processing yield.

### SUMMARY OF THE INVENTION

It is an object of the present invention to provide a chip package that the bonding wires thereof have better profiles whereby the chip package can be manufactured with a high processing yield and a good reliability.

It is another object of the present invention to provide a wire bonding process that creates the bonding wires with better profiles and whereby the occurrence of that the bonding wires contact the elements on the substrate can be avoided and the processing yield is increased accordingly.

In view of the above, the present invention provides a chip package that comprises a circuit substrate, a chip, a bonding wire and a leaning block. The circuit substrate has a bonding surface and at least one contact disposed the bonding surface. The chip is disposed on the bonding surface of the circuit substrate, wherein the chip has an active surface facing opposite to the circuit substrate and at least one bonding pad disposed on the active surface. The leaning block is disposed on the contact. The bonding wire connects the bonding pad and the contact and passes over the leaning block.

The circuit substrate in the chip package according to the present invention further comprises a ground ring and/or a power ring disposed around the chip and between the chip and the contact.

The leaning block and bonding wire in the chip package according to the present invention are made of the same material.

The leaning block in the chip package according to the present invention is made of gold or epoxy resin.

The chip package according to the present invention further comprises an encapsulant disposed on the bonding surface of the circuit substrate and encapsulating the chip, bonding wire, leaning block and contact.

The present invention further provides a wire-bonding process. Firstly, a circuit substrate is provided, wherein the circuit substrate has at least one bonding surface and at least one contact disposed on the bonding surface. Secondly, a chip is disposed on the bonding surface of the circuit substrate, wherein the chip has an active surface facing opposite to the circuit substrate and at least one bonding pad disposed on the active surface. Thirdly, a leaning block is formed on the contact. Lastly, one end of a bonding wire is bonded to the bonding pad by a wire-bonding machine. The bonding wire is drawn by the wire-bonding machine and passes over the leaning block, and then is bonded to the contact.

The method for forming the leaning block on the contact according to the wire bonding process of the present invention is to form a metal bump on the top of the contact by a wire-bonding machine.

The leaning block according to the wire bonding process of the present invention can be formed by dispensing or printing. In addition, the wire bonding process of the present invention further comprises a curing step curing the leaning block after dispensing or printing.

The circuit substrate according to the wire bonding process of the present invention further comprises a ground ring and/or a power ring disposed around the chip and between the chip and contact.

According to the wire bonding process of the present invention, the leaning block is preformed on the contact of the circuit substrate before wire bonding so as to keep the profile of the bonding wire after wire bonding. This will prevent the bonding wire from drooping and thus that the bonding wire bridges to other lines on the circuit substrate can be avoided. By doing so, the processing yield will be increased accordingly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram showing a chip is bonded to a circuit substrate by a conventional wire bonding process.

FIG. 2 is a schematic diagram showing a chip is bonded to a circuit substrate by another conventional wire bonding process.

FIGS. 3A to 3C are schematic diagrams showing a wire bonding process in sequence according to the preferred embodiment of the present invention.

FIG. 4 is a schematic diagram showing a chip package according to the preferred embodiment of the present invention.

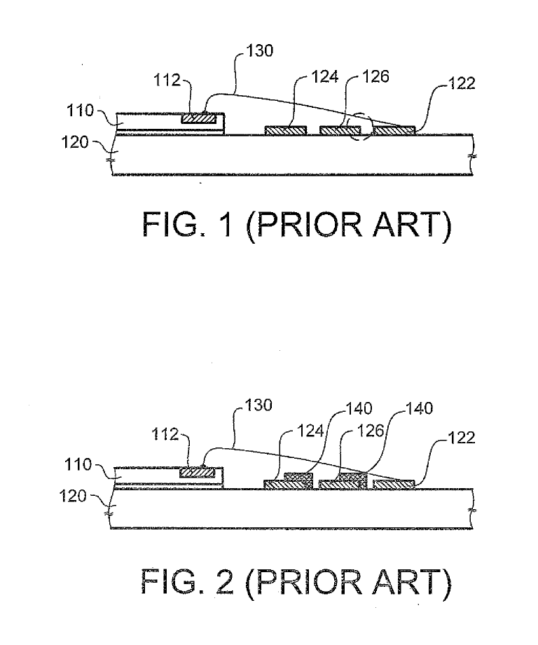

### DETAILED DESCRIPTION OF THE PREFERRED EMBODIMENT

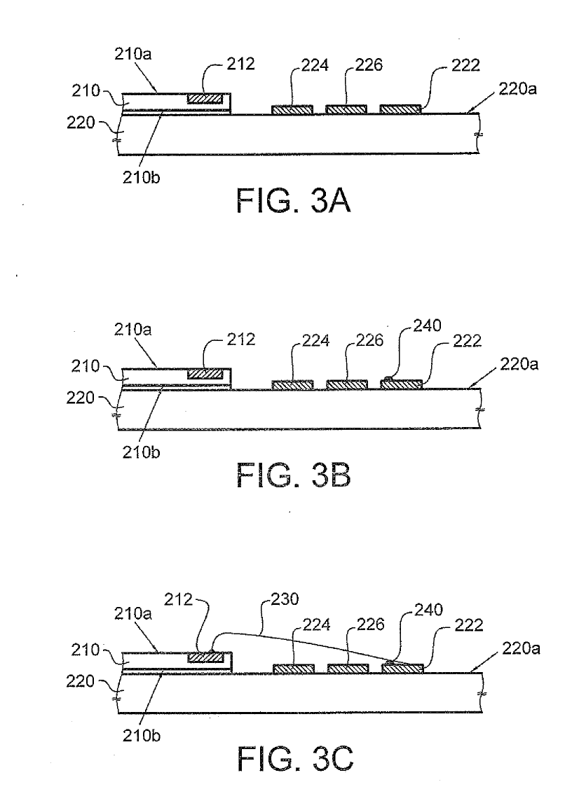

Referring to FIGS. 3A to 3C, which are schematic diagrams showing a wire bonding process in sequence according to the preferred embodiment of the present invention.

Firstly, as shown in FIG. 3A, a chip 210 is disposed on the bonding surface 220a of a circuit substrate 220, wherein the back surface 210b of the chip 210 is bonded to the circuit substrate 220 and a plurality of bonding pads 212 is disposed on the active surface 210a of the chip 210. In addition, a plurality of contacts 222 is disposed on the bonding surface 220a of the circuit substrate 220 and around the chip 210. For example, the contacts 222 are gold fingers or other types of line contacts. In this embodiment, a ground ring 224 and a power 226 are disposed on the circuit substrate 220 and between the chip 210 and the contacts 222.

Secondly, as shown in FIG. 3B, a leaning block 240 is formed on the contact 222. In this embodiment, the method for forming the leaning block 240 is to preform a metal bump on the top 222a of the contact 222 by a wire-bonding machine before wire bonding. The leaning block 240 can be made of gold or materials suitable for wire bonding. In other embodiments of the present invention, the leaning block 240 can be formed on the contact 222 by printing or dispensing. The leaning block 240 can be made of epoxy resin and other suitable materials. In addition, if the leaning block 240 is made of epoxy resin and formed by printing or dispensing, a curing step can be used to cure the leaning block 240 after forming the leaning block 240.

Lastly, as shown in FIG. 3C, one end of a wire is bonded to the bonding pad 212 of the chip 210 by a wire-bonding machine. The wire is drawn by the wire-bonding machine and passes over the leaning block 240, and then is bonded to the contact 222. By doing so, a bonding wire 230 is formed and bonded to the bonding pad 212 and contact 222. The bonding wire 230 can be made of gold or materials with good conductivity.

As mentioned above, because the leaning block 240 is below the bonding wire 230 and disposed right on the top 222a of the contact 222, the bonding wire 230 leans against the leaning block 240 and thus the profile thereof can be kept. By doing so, the occurrence of that the bonding wire 230 contacts the power ring 226 or ground ring 224 can be avoided and thus the problem of short circuit is solved. It should be noted that although the present invention has been illustrated in relation to its preferred embodiment described above, it is not used to limit the invention. For example, the present invention can be used in the case of wire bonding signal contacts to each other and the case suitable for wire bonding.

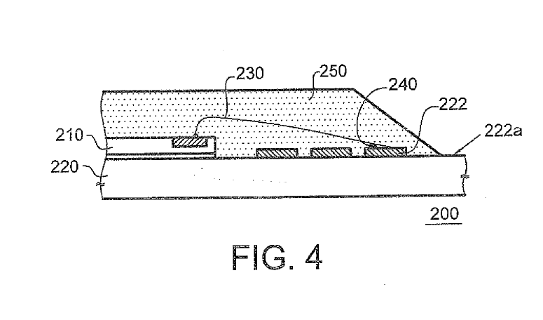

FIG. 4 is a schematic diagram showing a chip package according to the preferred embodiment of the present invention. As shown in FIG. 4, a molding process can proceed after the wire bonding process. A chip package 200 is formed by forming an encapsulant 250 on the bonding surface 220a of the circuit substrate 220, wherein the encapsulant 250 encapsulates at least the chip 210, bonding wire 230, leaning block 240 and contact 222.

As mentioned above, the wire bonding process according to the present invention is to preform a leaning block on the contact of the circuit substrate before wire bonding. Because the bonding wire leans against the leaning block, the profile of the bonding wire can be kept. This will prevent the bonding wire from drooping and thus avoid the occurrence of that the bonding wire bridges to other lines on the circuit substrate. The chip package can be manufactured with high processing yield and a good reliability.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A chip package, comprising:
a circuit substrate having a bonding surface and at least one contact disposed on the bonding surface;
a chip disposed on the bonding surface of the circuit substrate, wherein the chip has an active surface facing opposite to the circuit substrate and at least one bonding pad disposed on the active surface;
a leaning block disposed on the contact; and
a bonding wire connecting the bonding pad and contact and passing over the leaning block.

2. The chip package as claimed in claim 1, wherein the circuit substrate further comprises a ground ring disposed around the chip and between the chip and contact.

3. The chip package as claimed in claim 1, wherein the circuit substrate further comprises a power ring disposed around the chip and between the chip and contact.

4. The chip package as claimed in claim 1, wherein the leaning block and bonding wire are made of the same material.

5. The chip package as claimed in claim 1, wherein the leaning block is made of gold.

6. The chip package as claimed in claim 1, wherein the leaning block is made of epoxy resin.

7. The chip package as claimed in claim 1, further comprising an encapsulant disposed on the bonding surface of the circuit substrate and encapsulating the chip, bonding wire, leaning block and contact.
